(19) United States
(12) Patent Application Publication
(10) Pub. No.: US 2003/0066586 A1
(43) Pub. Date: Apr. 10, 2003

(54) Airbag cover

(76) Inventors: Frank Blockhaus, Velbert (DE); Udo Kansteiner, Witten (DE); Wolfgang Gundlach, Bochum (DE)

Correspondence Address: CHARLES K. VEENSTRA, DELPHI TECHNOLOGIES, INC., Legal Staff, Mail Code: 480-414-420, P.O. Box 5052, Troy, MI, 48007-5052, US

(21) Appl. No.: 10/251,897

(22) Filed: Sep. 20, 2002

(30) Foreign Application Priority Data
Oct. 5, 2001 (DE) 10149038.0
Sep. 2, 2002 (DE) 10240439.9

(51) Int. Cl. B32B 5/18; B32B 31/14; B32B 31/00

(52) U.S. Cl. 156/78; 156/256

(57) ABSTRACT

A method of manufacturing an airbag cover is set forth in which at least one recess is formed in the inner side of the cover layer at the location of the tear-open position and is substantially sealingly closed by a cover film, with foam material being applied onto the cover layer and onto the cover film.

### TECHNICAL FIELD

The invention relates to a method of manufacturing an airbag cover, to an airbag cover and to an apparatus for the manufacture of the airbag cover.

### BACKGROUND OF THE INVENTION

Airbag covers are known which are provided with a cover layer at the side directed towards the passenger compartment of a vehicle. The cover layer has, in addition to a decorative function, the task of covering over a tear-open position which serves as the position of the intended fracture of the airbag cover. In this manner the tear-open position is not visible in the vehicle compartment. A recess is provided in the inner side of the cover layer in order that the cover layer is reliably torn open at the position of intended fracture during the unfolding of the airbag. This recess is namely a linear perforation which is introduced with cutting techniques, for example by cutting with a laser. The laser cutting technique can however a lead to an aging of the material of the cover layer as result of the heat that arises. In the event of such aging the tear-open position is however visible in the interior compartment of the vehicle.

Alternatively the recess can be provided by cutting with a cold knife. This leads however to the problem, as do other cutting techniques, that during the application of a foam material layer to the inner side of the cover layer the recess of the tear-open line is closed again. This takes place because of the forces of attraction between the materials of the foam and of the cover layer, which can both contain PU (polyurethane), would lead to problems during the unfolding of the airbag and the tearing open of the airbag cover.

Since the airbag cover, which can, for example, be integrated into a dashboard or into a cover for a door, is a safety critical part, the manufacture of the airbag cover and thus also of the tear-open position must be monitored and documented process-wise.

### SUMMARY OF THE INVENTION

The object of the invention is to set forth an improved method for the manufacture of an airbag cover, an airbag cover and an apparatus for the manufacture of an airbag cover with which the above-named disadvantages are avoided. Moreover, the method for the manufacture of an airbag cover should enable a documentation of the manufacturing process and in particular of the formation of the tear-open position.

This object is satisfied by the features of claim 1.

The object is in particular satisfied, in a method of manufacturing an airbag cover, in that at least one recess formed in the inner side of the cover layer at the location of the tear-open position is substantially sealingly closed by a cover film, in particular a strip-like cover film and foam material is applied onto the cover layer and onto the cover film in order to form the foam material layer.

Since the recess with the cover film is substantially sealingly closed no foam penetrates into the recess during the application of the foam material onto the cover layer. This avoids the recess filling with foam material and thereby making more difficult or preventing a tearing open of the airbag cover at the position of the intended fracture of the cover layer, namely at the recess. In addition, because of the use of the cover film, only a flat structure arises over the recess so that the foaming process for the formation of the foam material layer is not impaired. This all leads to a favorable tear-open behavior of the airbag cover, including the tearing open of the cover layer at the tear-open position. Moreover the so-formed tear-open position laminated with the cover layer is not recognizable in the passenger compartment of the vehicle.

In the method the inner side of the cover layer can be provided with the recess at the location of the tear-open position. Thus a process is realized in which both the formation and also the closing of the recess and the foaming of the foam material can be carried out rapidly and simply and can additionally be monitored. Alternatively, a cover layer already provided with a recess can be used.

The recess can be formed by cutting with an unheated knife. This prevents an aging of the material of the cover layer at the tear-open position caused by heat which can for example arise on cutting with a laser. This ensures that the location of the recess and thus of the tear-open position is not recognizable in the passenger compartment of the vehicle.

The recess is preferably of linear design. In this manner a hidden airbag door can be provided in the airbag cover, with the recess pre-defining the outline of the hidden airbag door.

It is particularly advantageous when a self-adhesive, adhesive strip, in particular a flexible adhesive strip, is used as the cover film. This enables, on the one hand, a simple application of the adhesive strip onto the cover layer at the edges of the recess. On the other hand, as a result of the flexibility and of the self-adhesive characteristic of the adhesive strip, the fracture behavior of the cover layer or of the airbag cover at the tear-open position is not impaired.

Furthermore, a cover film, in particular a strip-like cover film can be used with a material and a surface nature such that the cover film can be wetted by the foam material. In this manner it is ensured that a closed material foam layer is also formed on the cover film, which does not have any disadvantageously changed structure, such as for example excessive air inclusions. This ensures a reliable loadability of the airbag cover when it is installed in a dashboard or in a trim panel for a door.

In a preferred embodiment a cover film, in particular a colored cover film is used which is optically distinguished from the background. In this way an improve control of the method steps is make possible, in particular by a photographic documentation, which is of advantage for safety relevant parts such as an airbag cover in a dashboard or in panel for a door.

The cover layer provided with the recess can in particular be positioned in a foaming tool such that the recess faces the hollow cavity of the foaming tool. The cover film can be applied by a robot to the tear-open position and foam material can be foamed onto the cover layer and the cover film. This manner of proceeding enables a manufacture of the airbag cover with customary tools so that complicated and costly improvement of existing machines is superfluous.

The object is further satisfied by an airbag cover which can be obtained with an above recited method.

Moreover, the object is satisfied by an apparatus for the manufacture of an airbag cover wherein the apparatus has a foaming tool with a hollow cavity for receiving a pre-manufactured cover layer and in particular a closure device with a cover film is provided for the sealed closure of at least one recess which is provided at the location of the tear-open position in the inner side of the cover layer. This apparatus enables the above-mentioned method to be carried out and thus the manufacture of an airbag cover with above-named advantages.

In addition, in the apparatus for the manufacture of an airbag cover, a cutting device with an unheated knife can be provided for the cutting of the recess in the inner side of the cover layer. For this apparatus an aging of the cover layer caused by heat during formation of the recess is avoided.

Furthermore, the closure device and/or the cutting device can be provided on an arm of a robot. In this way a method can be carried out in which a pre-manufactured cover layer is positioned in a foaming tool, if required a recess is formed in a cover layer by cutting, the pre-manufactured formed recess is closed by a cover film and foam is subsequently foamed onto the cover layer and the cover film in order to form the foam material layer of the airbag cover. Thus, an apparatus is provided with which all steps for the manufacture of an airbag cover can be simply and rapidly carried out with a covered over tear-open position. Moreover, the apparatus can, if required, be simply converted in that for example the cutting device can be replaced by another cutting device. At the same time relevant safety regulations and the aesthetic requirements placed on the airbag cover can be satisfied.

### BRIEF DESCRIPTION OF THE DRAWINGS

In the following the invention will be described purely by way of example and with reference to the accompanying drawings in which are shown:

FIG. 1 is a cross-sectional view through an embodiment of an airbag cover in accordance with the invention in the region of a covered over tear-open position, and

FIG. 2 is an enlarged cross-sectional view of the airbag cover shown in FIG. 1.

### DESCRIPTION OF THE PREFERRED EMBODIMENT

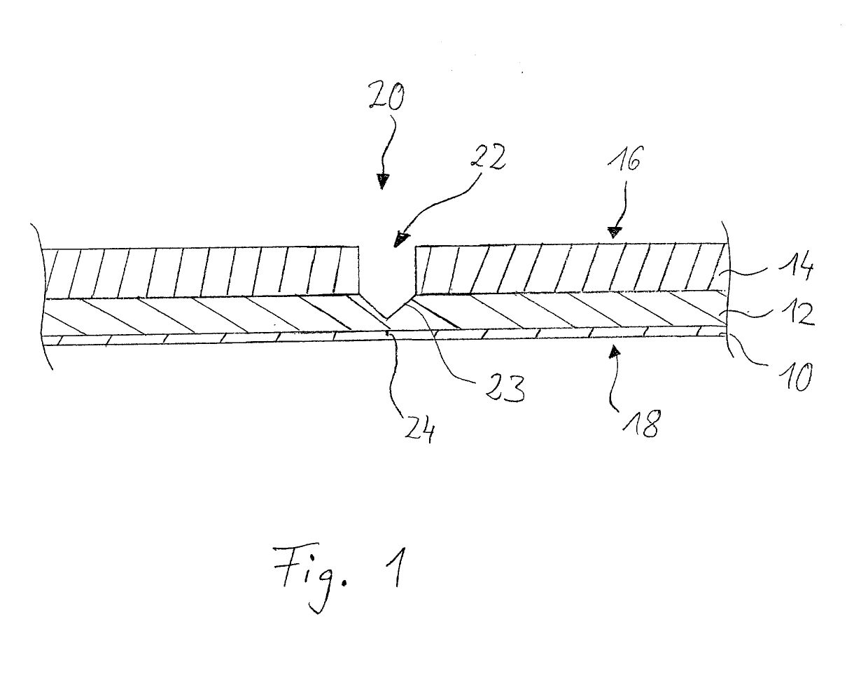

As shown in FIG. 1 an embodiment of an airbag cover in accordance with the invention includes a cover layer 10 of PU (polyurethane), a foam material layer 12 of PU arrange on the cover layer 10 and a carrier layer 14 arranged on the foam material layer 12.

The carrier layer 14 is provided at the inner side 16 of the airbag cover facing the airbag, while the outer side 18 of the airbag cover, which faces the passenger compartment of the vehicle, is formed by the cover layer 10.

A position of intended fracture 20 is provided in the airbag cover, with the carrier layer 14 having an opening 22 at the position of intended fracture. The foam material layer 12 is provided at the position of intended fracture 20 with a V-shaped recess 23. The recess 23 forms a continuation of the opening 22 and tapers, starting form the edges of the opening 22, in the direction of the cover layer 10.

As a consequence both the carrier layer 14 and also the foam material layer 12 have a material weakness at the position of the intended fracture 20 at which they can open in the event of triggering of the airbag. The foam material 12 can also be formed without the recess 23 if its layer thickness is so small that it will reliably tear open at the position 20 of intended fracture on an unfolding of the airbag.

For the purpose of forming a material weakening in the cover layer 10 the latter is provided at the position of intended fracture 10 with a V-shaped recess 24. The recess 24 is formed in the inner side of the cover layer 10 facing the foam material layer 12 and tapers towards the outer side 18 of the airbag cover. In this manner the recess 24 is not visible in the passenger compartment of the vehicle. Since the recess 24 is not filled with foam material or with another material it is formed as a hollow space.

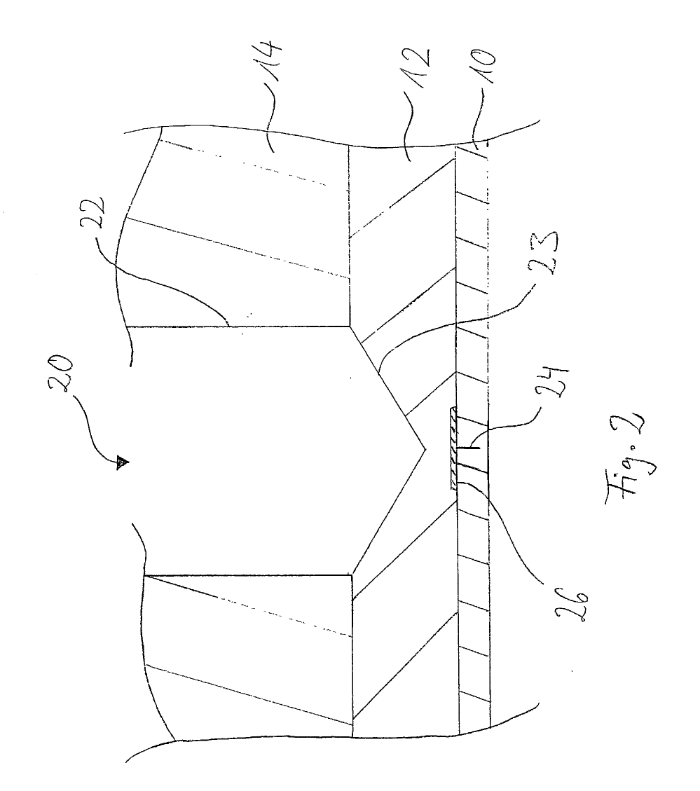

As is evident from FIG. 2 a cover film 26 is located above the recess 24 between the cover layer 10 and the foam material layer 12.

During the manufacture of the airbag cover the cover layer 10, which is separately manufactured and was provided with the recess 24 by cutting with a cold knife, is laid into the hollow cavity of a foaming tool. In this arrangement the recess 24 is aligned facing the hollow cavity. Then a robot subsequently applies a cover film 26, which consists of a flexible and a self-adhesive plastic strip, onto the cover layer 10 above the recess 24.

The carrier layer 14 is then secured in the hollow cavity of a foaming tool opposite to the cover layer on an insert of the foaming tool. This insert has a wedge-like projection, the shape of which forms the recess 23 during foaming. The carrier layer 14 is placed onto the insert in such a way that the projection projects through the opening 22.

Thereafter an intermediate space is set as desired between the cover layer 10 and the carrier layer 14. Finally, for the forming of the foam material layer 12, PU-foam is introduced into the intermediate space and it is filled up.

As the cover film 26 sealingly closes the recess 24 no foam enters the recess 24 whereas the cover layer and the cover film 26 are fully covered with foam. The latter is assisted by the fact that the cover film 26 is formed of a material and has a surface nature which bring about a good wet ability with the foam of the foam material layer 12.

In this manner the foam material layer 12 is formed between the carrier layer 14 and the cover layer 10 without the recess 24 filling with foam. Through the cover film 26 the forces of attraction between the materials of the cover layer 10 and of the foam are namely counteracted in the region of the recess 24. The recess 24 consequently remains as a hollow cavity in the layer sequence of the airbag cover which cannot be recognized from the outside 18. This ensures a reliable tearing open of the whole airbag cover, including the cover layer 10, at the point of intended fracture 20.

In the method indicated the recess 24 is provided in the cover layer 10 by cutting with a non-heated knife. Thus, an aging of the cover layer 10 caused by heat is avoided, which would otherwise make itself noticeable at the outer side 18 of the airbag cover.

Moreover, the cover film 26 has a color which is significantly distinguished from the color of the cover layer 10. In this way the application of the cover film 26 can be followed with a camera and can be documented, which is necessary as results of safety regulations.

1. A method for manufacturing an airbag cover having a covering layer (10) which has an outer side facing the passenger compartment and an inner side, a foam material layer (12) at the inner side of the covering layer (10) and a covered tear-open position,
characterized in that
at least one recess (24) formed in the inner side of the cover layer (10) at the location of the tear-open position is substantially sealingly covered by a cover film (26), in particular a strip-like cover film and foam material is applied onto the cover layer (10) and onto the cover film (26) to form the foam material layer (12).

2. A method in accordance with claim 1,
characterized in that
the inner side of the cover layer (10) is provided at the location of the tear-open position with the recess (24).

3. A method in accordance with claim 1 or claim 2,
characterized in that
the recess (24) is formed by cutting with an unheated knife.

4. A method in accordance with one of the preceding claims,
characterized in that
the recess (24) is made of line-like shape.

5. A method in accordance with one of the preceding claims,
characterized in that
a self-adhesive adhesive strip, in particular a flexible, self-adhesive, adhesive strip is used as the cover film (26).

6. A method in accordance with one of the preceding claims,
characterized in that
a cover film (26), in particular a strip-like cover film is used with a material and a surface nature such that the cover film (26) can be wetted by the foam material.

7. A method in accordance with one of the preceding claims,
characterized in that
a cover film (26), in particular a colored cover film (26), is used which is optically distinguished from the background.

8. A method in accordance with one of the preceding claims,
characterized in that the cover layer (10) provided with the recess (24) is positioned in a foaming tool in such a way that the recess (24) faces the hollow cavity of the foaming tool, the cover film (26) is applied by a robot to the tear-open position and foam material is foamed onto the cover layer (10) and the cover film (26).

9. A method in accordance with one of the preceding claims,
characterized in that
the method steps are documented, in particular photographically.

10. An airbag cover obtainable with a method in accordance with any one of the preceding claims.

11. An apparatus for the manufacture of an airbag cover with a cover layer (10) which has an outer side facing the passenger compartment of a vehicle and an inner side, a foam material layer (12) at the inner side of the cover layer (10) and a covered tear-open position, the apparatus having a foaming tool with a hollow cavity for the reception of the pre-manufactured cover layer (10),
characterized by
a closure device with a cover film (26) for the sealed closure of at least one recess (24) which is provided at the location of the tear-open position in the inner side of the cover layer (10).

12. An apparatus in accordance with claim 11,
characterized in that
a cutting device with an unheated knife is provided for the cutting of the recess (24) in the inner side of the cover layer (10).

13. An apparatus in accordance with claim 11 or 12,
characterized in that the
closure device and/or the cutting device are provided on an arm of a robot.
